(19) United States
(12) Patent Application Publication
(10) Pub. No.: US 2026/0283325 A1
(43) Pub. Date: Sep. 24, 2026

(54) HAIRDRYER

(71) Applicant: Dyson Technology Limited, Malmesbury, Wiltshire (GB)

(72) Inventors: Christopher James BOON, Singapore (SG); Jeffrey ANTHONY JESUDASAN, Bristol (GB); Lorenzo Villacarlos ALTONAGA, Taguig (PH)

(21) Appl. No.: 19/475,549

(22) PCT Filed: Apr. 3, 2024
(86) PCT No.: PCT/IB2024/053216

§ 371 Date: Oct. 15, 2025

(30) Foreign Application Priority Data
Apr. 25, 2023 (GB) 2306070.0

(51) Int. Cl. A45D 20/12; G01S 7/481; G01S 17/08

(52) U.S. Cl. CPC A45D 20/12; G01S 7/4814; G01S 7/4816; G01S 17/08

(57) ABSTRACT

A hair dryer is provided and may include an optical device, a field of illumination restrictor, and a field of view restrictor. The optical device includes an emitter configured to emit optical radiation and a detector configured to receive optical radiation. The field of illumination restrictor is configured to restrict a field of illumination of the emitter. The field of view restrictor is configured to restrict a field of view of the detector. The field of view restrictor is separate to the field of illumination restrictor.

### BACKGROUND

Some hairdryers may comprise optical devices for sensing properties related to drying hair of a user of the hairdryer.

### SUMMARY

According to a first aspect of the present invention, there is provided an optical device, the optical device comprising: an emitter configured to emit optical radiation and a detector configured to receive optical radiation; a field of illumination restrictor configured to restrict a field of illumination of the emitter, and a field of view restrictor configured to restrict a field of view of the detector; wherein the field of view restrictor is separate to the field of illumination restrictor. As a result, the Field of Illumination (FoI) and Field of View (FoV) may be restricted by different amounts. Restricting the FoI and FoV by different amounts may be desirable to enable optimisation of the performance of the optical device for the specific needs of the hair dryer. For example, restricting the FoI by a large amount and restricting the FoV by a small amount. Restricting the FoI by a large amount may improve the performance of the optical device when sensing an object (such as a user's head) in a defined area because the amount of emitted optical radiation which hits objects outside the defined area and subsequently reflects back to the detector (and thereby constitutes noise) may be reduced. Thereby the signal to noise ratio may be increased, which may increase the likelihood of an object being successfully detected. Restricting the FoV by a small amount may result in a greater proportion of the reflected optical radiation being received by the detector, which may increase the signal strength.

Restricting the FoV and FoI may also/alternatively enable the use of an off-the-shelf optical device whose FoV and/or FoI are not tailored to the specific needs of the hair dryer. Using an off-the-shelf optical device may reduce the cost of the hair dryer compared to having a bespoke optical device manufactured.

Optionally the emitter is an infrared emitter. Use of an infrared emitter may ensure that the emitted and/or reflected infrared radiation is not visible to a user.

Optionally, the field of illumination restrictor is configured to restrict the field of illumination of the emitter such that, in use, a full width at half maximum beam divergence of the optical radiation after the optical radiation has passed through the field of illumination restrictor has a first value; wherein the field of view restrictor is configured to restrict the field of view of the detector such that an acceptance angle of the field of view restrictor has a second value; and the first value is different to the second value. Optionally, the second value is larger than the first value. As described above, this may increase the performance of the optical device. The acceptance angle is measured from a central axis of the field of view restrictor.

Optionally, a minimum distance between the emitter and the detector is less than or equal to 20 mm, and more specifically less than or equal to 10 mm, or less than or equal to 3 mm. As a result, the optical device may have a more compact arrangement which may be more easily integrated into the hair dryer without impacting the performance of the hair dryer, for example, by obstructing an airflow path of the hair dryer.

Optionally, the field of illumination restrictor is configured to restrict the field of illumination of the emitter such that, in use, a full width at half maximum beam divergence of the optical radiation after the optical radiation has passed through the field of illumination restrictor is less than or equal to 20. As described above, sensing of objects within a defined area may be desirable, for example, substantially perpendicular to an outlet of the hair dryer. A lower beam divergence may result in the amount of emitted optical radiation which hits objects outside the defined area and subsequently reflects back to the detector as noise being reduced. This may increase the signal to noise ratio, which may increase the likelihood of an object being successfully detected. Therefore, having a beam divergence of less than or equal to 20, and more particularly less than or equal to 15°, or less than or equal to 10°, may increase the signal to noise ratio. Optionally, the full width at half maximum beam divergence of the optical radiation after the optical radiation has passed through the field of illumination restrictor is less than or equal to 15°, or less than or equal to 10°.

Optionally, the field of illumination restrictor is configured to restrict the field of illumination of the emitter such that, in use, a full width at half maximum beam divergence of the optical radiation after the optical radiation has passed through the field of illumination restrictor is greater than or equal to 4°. A higher beam divergence may result in the likelihood of the optical radiation missing the object, and thereby not detecting the object, decreasing. Therefore, having a beam divergence of greater than or equal to 4°, and in particular greater than or equal to 6°, may increase the likelihood of the object being detected. Optionally, the full width at half maximum beam divergence of the optical radiation after the optical radiation has passed through the field of illumination restrictor is greater than 6°.

Furthermore, having a beam divergence of between 4° and 20°, and more particularly between 6° and 10°, may provide a good balance between the competing needs of decreasing the noise, and decreasing the likelihood of the emitted optical radiation missing the object.

Optionally, the field of view restrictor is configured to restrict the field of view of the detector such that an acceptance angle of the field of view restrictor is less than or equal to 10°. As described above, sensing of objects within a defined area may be desirable. By having an acceptance angle of less than or equal to 10, the amount of optical radiation from outside this defined area which is received by the optical device, and thereby constitutes noise, may be reduced. Thereby the performance of the optical device may be improved by reducing the amount of noise, which may increase the signal to noise ratio. The inventors have observed that the amount of noise reduces to a greater extent below 8, and an even greater extent below 6.5°. Optionally, the acceptance angle is less than or equal to 8°. Optionally, the acceptance angle is less than or equal to 6.5°.

Optionally, the field of view restrictor is configured to restrict the field of view of the detector such that an acceptance angle of the field of view restrictor is greater than or equal to 3°. A greater acceptance angle may result in the field of view restrictor being able to accept a greater proportion of the reflected optical radiation, which may increase the signal strength. Thereby, have an acceptance angle of greater than or equal to 3° may increase the signal strength. Furthermore, having an acceptance angle of between 8° and 3°, may provide a good balance between increasing the signal strength and reducing the noise.

Optionally, the hair dryer comprises a main body, and the optical device, the field of illumination restrictor, and the field of view restrictor are located inside the main body. Locating the optical device, the field of illumination restrictor, and the field of view restrictor inside the main body may provide a more compact arrangement for the hair dryer when compared with locating the optical device, the field of illumination restrictor, and/or the field of view restrictor outside the main body. This may improve the ergonomics of the hair dryer.

Without the field of illumination restrictor, optical radiation emitted from the emitter may be reflected from internal surfaces within the main body, which may act as noise to the detector and/or reduce the amount of optical radiation directed towards the target to be sensed. Therefore, using the field of illumination restrictor to restrict the FoI may be beneficial in examples where the optical device, the field of illumination restrictor, and the field of view restrictor are located inside the main body.

Additionally/alternatively, without the field of view restrictor, there may be additional noise received by the detector due to optical radiation reflected from internal surfaces within the main body and/or produced by other components of the hair dryer (for example a heater). Therefore, using the field of view restrictor to restrict the FoV may be beneficial in examples where the optical device, the field of illumination restrictor, and the field of view restrictor are located inside the main body.

Optionally, the hair dryer comprises: an attachment attachable to the main body; the attachment comprises an outlet which is spaced apart from the main body when the attachment is attached to the main body; and the field of illumination restrictor is configured to restrict the field of illumination such that, in use, a ratio of a full width at half maximum beam width of the optical radiation at the outlet of the attachment to a minimum width of the outlet of the attachment is less than or equal to 1.5; or the field of view restrictor is configured to restrict the field of view such that a ratio of a width of the field of view at the outlet of the attachment to the minimum width of the outlet of the attachment is less than or equal to 1.5. An attachment may provide additional functionality to the hair dryer. However, optical radiation emitted from the emitter, and/or emitted by other components of the hair dryer (such as a heater) may be reflected from an inside of the attachment and directed towards the detector. This may increase noise and reduce the signal to noise ratio, and/or reduce the amount of optical radiation directed towards the target to be sensed. Thereby, the performance of the optical device may be reduced.

By reducing the field of view to such that the ratio of the width of the field of view at the outlet of the attachment to the minimum width of the outlet of the attachment is less than or equal to 1.5, the detector may receive less of the optical radiation reflected from the inside of the attachment and thereby the signal to noise ratio may be increased.

By reducing the field of illumination such that the ratio of the full width at half maximum beam width of the optical radiation at the outlet of the attachment to the minimum width of the outlet of the attachment is less than or equal to 1.5, the amount of optical radiation emitted by the emitter and reflected towards the detector by the attachment may be reduced, which may increase the signal to noise ratio. Equally, a greater proportion of the emitted optical radiation may be directed towards an object to be sensed rather than reflected from the inside of the attachment.

Optionally, the optical device is a time of flight sensor. Time of flight sensors may be desirable in a hair dryer for enabling functions such as detecting the distance to the head of a user. The performance of a time of flight sensor may be particularly sensitive to low strength and/or low signal to noise ratio. For example, a low signal strength or low signal to noise ratio may prevent an object from being accurately detected. Therefore, the field of illumination restrictor and the field of view restrictor may be beneficial when the optical device is a time of flight sensor.

Optionally, the hair dryer comprises a first surface; the field of illumination restrictor is a portion of the first surface which defines a first channel, the first channel aligned with the emitter; the first channel comprises a first opening, a second opening further from the emitter than the first opening, and a width which increases monotonically between the first opening and the second opening; and the portion of the first surface that defines the first channel is configured to direct the optical radiation between the first opening and the second opening. As a result of the shape of the portion of the first surface, the FoI may be restricted whilst reducing the amount of optical radiation which is wasted when compared with a differently shaped portion which modifies the FoI without directing the optical radiation. The optical radiation may be wasted by not being usefully directed towards a target to be sensed. By reducing the amount of wasted optical radiation, a greater proportion of the emitted optical radiation may be able to hit and be reflected from an object to be sensed. Therefore, there may be a greater amount of reflected optical radiation which may then be received by the optical device to sense the object. This may improve the signal to noise ratio and/or the strength of the signal and thereby the performance of the optical device, which may increase the likelihood of an object being successfully detected.

Additionally, using a portion of a surface to modify the FoI rather than using a lens to modify the FoI, may improve the ease of manufacture (because aligning and tolerancing of the lens is not required), and/or reduce the cost of the hair dryer due to the relative cost of a lens compared to a surface.

Optionally, the first channel has a central axis extending between the first opening and the second opening; and at least a portion of the first channel has a circular profile about the central axis; and/or the portion of the first surface which defines the first channel is curved, between the first opening and the second opening, in a plane that includes the central axis. As a result, the amount of optical radiation which is wasted may be reduced when compared to a having a non-circular profile and/or a non-curved portion. This may increase the performance of the optical device.

Optionally, the portion of the first surface which defines the first channel and is curved, between the first opening and the second opening, conforms to the profile of a compound parabolic concentrator. Compound parabolic concentrators may be beneficial because a greater range of beam divergences may be achieved for the emitted optical radiation than may be achieved with a differently shaped curved surfaces, such as a parabolic reflector. A greater range of beam divergences may be desirable for tailoring the performance of the emitter to the hair dryer.

Optionally, the portion of the first surface which defines the first channel and is curved, between the first opening and the second opening, has the shape of a truncated compound parabolic concentrator. The shape of a truncated compound parabolic concentrator is a compound parabolic concentrator with a section removed, such that a length of the compound parabolic concentrator, measured along the central axis, is reduced. Whilst truncating the compound parabolic concentrator may reduce the performance of the compound parabolic concentrator relative to a non-truncated compound parabolic concentrator, a truncated compound parabolic concentrator may nevertheless achieve adequate performance whilst also being sufficiently compact to fit within the size constraints of the hair dryer.

Optionally, the shape of the truncated compound parabolic concentrator is a compound parabolic concentrator with a section removed coincident with the second opening. The inventors have observed that truncating the compound parabolic concentrator at the second opening, rather than the first opening, may reduce the amount of optical radiation wasted.

Optionally, the portion of the first surface has a minimum length, measured between the first opening and the second opening, of less than or equal to 20 mm and/or greater than or equal to 5 mm. Being less than or equal to 20 mm, may provide a more compact arrangement, which may be accommodated within the size constrains of the hair dryer. Additionally, a compact arrangement may have a reduced impact on the performance of the hair dryer, for example, by obstructing an airflow path of the hair dryer.

The ability of the portion to direct the optical radiation may decrease rapidly below 5 mm. Therefore, by having a length of greater than or equal to 5 mm, the ability of the portion to direct the optical radiation may be increased. Furthermore, having a minimum length of between 20 mm and 5 mm, and more specifically 12 mm and 8 mm, may provide a good balance between achieving adequate performance and a sufficiently compact arrangement to fit within the size constraints of the hair dryer.

Optionally, the minimum length of the portion of the first surface is greater than or equal to 8 mm and/or less than or equal to 12 mm.

Optionally, the emitter is coincident with the first opening of the first channel. As a result, the amount of optical radiation which is wasted may be reduced when compared to if the emitter were spaced from the opening of the first channel.

Optionally, the hair dryer comprises a second surface; the field of view restrictor is a portion of the second surface which defines a second channel, the second channel aligned with the detector; the second channel comprises a first opening, a second opening further from the detector than the first opening of the second channel, and a width which increases monotonically between the first opening of the second channel and the second opening of the second channel; and the portion of the second surface that defines the second channel is configured to direct the optical radiation between the first opening of the second channel and the second opening of the second channel. As a result of the shape of the portion of the second surface, the FoV may be restricted whilst reducing the amount of optical radiation which is wasted when compared with a differently shaped portion which modifies the FoV without directing the optical radiation. The optical radiation may be wasted by not being received by the detector. By reducing the amount of wasted optical radiation, a greater proportion of optical radiation which originates at an object to be sensed may be received by the detector. This may improve the signal strength and thereby may also improve the signal to noise ratio, which may increase the likelihood of an object being successfully detected.

Additionally, using a portion of a surface to modify the FoV rather than using a lens to modify the FoV, may improve the ease of manufacture (because aligning and tolerancing of the lens is not required), and/or reduce the cost of the hair dryer due to the relative cost of a lens compared to a surface.

Optional features of the portion of the first surface may be equally applied to the portion of the second surface, where appropriate.

Optionally, the optical device is a time of flight sensor and the hair dryer comprises a third channel which extends between the first channel and the second channel. The third channel may enable some optical radiation to pass between the first optical element and the second optical element, which may improve the calibration, and thereby the performance, of the optical device compared to if the third channel were omitted.

Optionally, the first channel has a second profile about the central axis, located between the circular profile and the second opening of the first channel, which has the shape of a first circular segment defined by a first circular arc and a first circular chord; the second channel comprises a second central axis extending between the first opening of the second channel and the second opening of the second channel, a second circular profile about the second central axis, and a third profile about the second central axis (located between the second circular profile and the second opening of the second channel) which has the shape of a second circular segment defined by a second circular arc and a second circular chord; and the first circular chord is opposite the second circular chord. Due to the increasing widths of the channels and the relative closeness of the emitter and the detector, the channels may merge into one another, which may reduce the performance of the optical device. By having the shape of circular segments with opposing chords, the emitter and the receiver may be located close together whilst also reducing the amount of each channel which merges with the other channel and thereby reduces the performance of the optical device.

Optionally, a central axis of the second opening of the first channel and a central axis of the second opening of the second channel are parallel. As a result, the FoI and FoV may not diverge from one another, which may reduce the likelihood of an area being produced in which the FoI and FoV do not overlap and therefore detection of objects is not possible.

### BRIEF DESCRIPTION OF THE DRAWINGS

FIG. 1 is an isometric view of a hair dryer according to an embodiment;

FIG. 2 is a side sectional view through a centre of a main body of the hair dryer;

FIG. 3 is a rear view of the main body;

FIG. 4 is an isometric view of a sensor assembly of the hair dryer

FIG. 5 is an isometric sectional view of the sensor assembly through a longitudinal plane;

FIG. 6 is a side sectional view of the sensor assembly through the longitudinal plane;

FIG. 7 is the same view as that of FIG. 6, in which different annotations to FIG. 6 are present;

FIG. 8 is a front sectional view of the sensor assembly through a first lateral plane;

FIG. 9 is a front sectional view of the sensor assembly through a second lateral plane;

FIG. 10 is a side sectional view of an emitter and a portion of a first surface of the sensor assembly, in which emitted optical radiation is shown;

FIG. 11 is a side sectional view of a detector and a portion of a second surface of the sensor assembly, in which reflected optical radiation is shown;

FIG. 12 is a schematic of electrical components of the hair dryer;

FIG. 13 is an isometric view of an attachment of the hair dryer;

FIG. 14 is a side sectional view of part of the hair dryer in which the attachment is attached to the main body;

FIG. 15 is a side sectional view of the emitter and the detector, in which emitted and reflected optical radiation is shown; and

FIG. 16 is a side sectional view of the emitter, detector, portion of the first surface and portion of the second surface of the sensor assembly, in which emitted and reflected optical radiation is shown.

### DETAILED DESCRIPTION

An example hair dryer according to the present invention will now be described. In general, hair dryers according to the present invention comprise an optical device. In the example hair dryer described below, the optical device of the hair dryer is a Time of Flight (ToF) sensor.

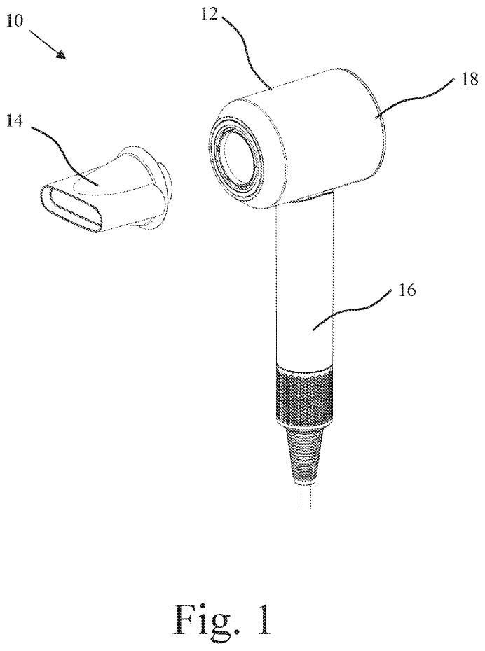

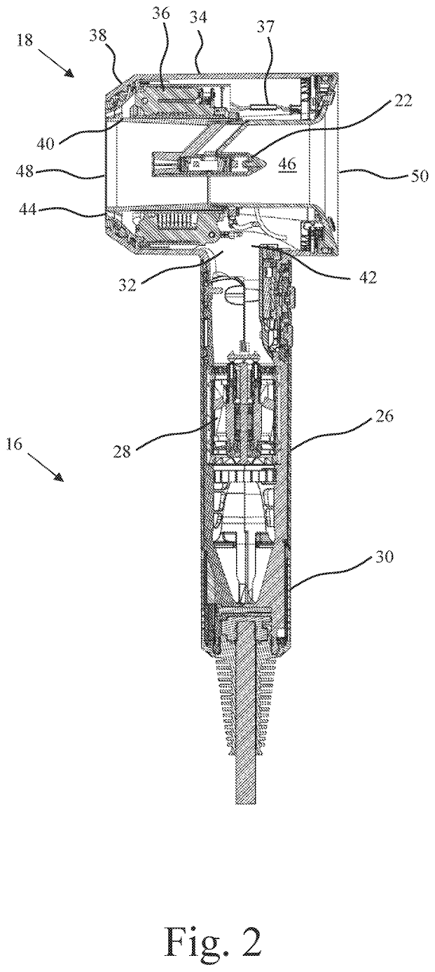

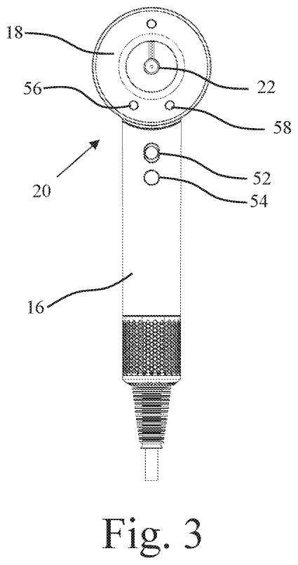

The hair dryer 10 of FIGS. 1 to 3 comprises a main body 12 and an attachment 14 attachable to the main body 12. The main body 12 comprises a handle section 16, a barrel section 18, user controls 20, and a sensor assembly 22

The handle section 16 is generally cylindrical in shape and comprises a housing 26 that houses an airflow generator 28. The housing 26 comprises an inlet 30 through which an airflow is drawn into the handle section 16 by the airflow generator 28, and an outlet 32 through which the airflow is discharged into the barrel section 18. The airflow generator 28 comprises a fan driven by an electric motor.

The barrel section 18 is likewise generally cylindrical in shape, but is shorter in length and wider in diameter than the handle section 16 in this example. The barrel section 18 is attached to an end of the handle section 16 and is oriented such that the longitudinal axes of the handle section 16 and the barrel section 18 are orthogonal. As a result, the shape of the main body 12 resembles a gavel or mallet.

The barrel section 18 comprises a housing 34 that houses a heater 36 and a control module 37. The housing 34 comprises an outer wall 38 and an inner wall 40 that are generally concentric and define a chamber within which the heater 36 and the control module 37 are housed. The housing 34 comprises an inlet 42 through which airflow from the handle section 16 enters the chamber, and an outlet 44 at an end of the barrel section 18 through which the airflow is discharged. The heater 36 is located between the inlet 42 and the outlet 44 and, when powered, heats the airflow. The inner wall 40 defines a bore 46 that extends through the centre of the barrel section 18. The bore 46 comprises an outlet 48 which is at the end of the barrel section which comprises the outlet 44 of the housing 34, and an inlet 50 at an opposite end of the barrel section 18 to the end which comprises the outlet 44 of the housing 34.

The user controls 20 are provided on both the handle section 16 and the barrel section 18, and comprise a first button 52 to power on and off the appliance 10, a second button 54 to momentarily power off the heater 36 such that the appliance 10 delivers a cold shot of air, a third button 56 to control the flow rate of the airflow, and a fourth button 58 to control the temperature of the airflow.

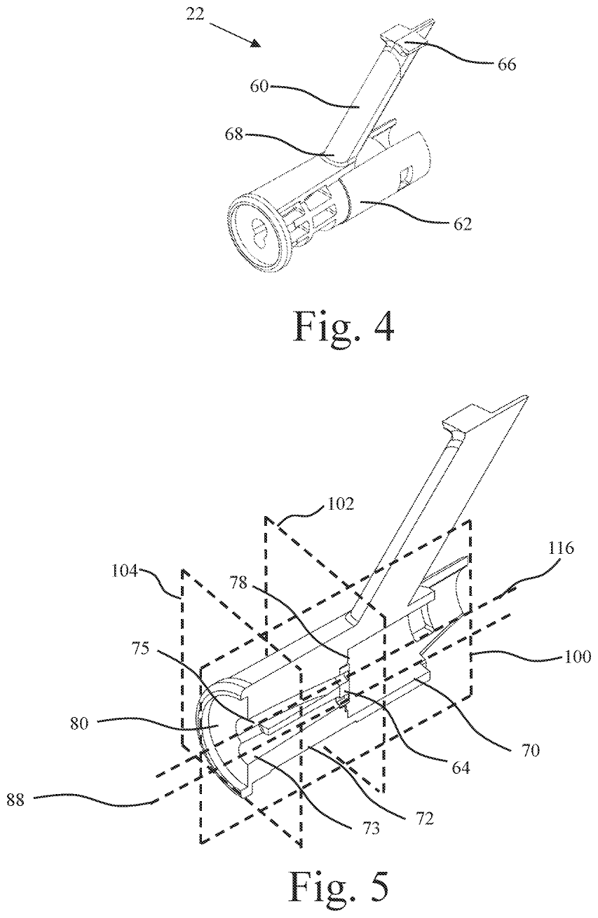

The sensor assembly 22 (shown in detail in FIGS. 4 to 9) comprises a strut 60, a main unit 62, and a ToF sensor 64 located in the main unit 62.

The strut 60 comprises a first end 66 and a second end 68. The first end 66 is connected to the inner wall 40 of the barrel section 18, and the second end 68 is connected to the main unit 62. The strut 60 supports the main body 62 within the bore 46.

The main unit 62 is located within the bore 46 and comprises a rear section 70 and a front section 72. The rear section 70 comprises a wall which is generally cylindrical in shape and defines a chamber within which the ToF sensor 64 is located. The front section 72 is generally cylindrical in shape and comprises a Field of Illumination Restrictor (FoI) 73 and a Field of View (FoV) restrictor 75. A rear face 78 of the front section 72 faces towards the chamber, and a front face 80 of the front section 72 faces away from the chamber and towards the outlet 48 of the bore 46.

The FoI restrictor 73 is a portion of a first surface 74 of the front section 72 which defines a first channel 82. The first channel 82 extends through the front section 72 between the front face 80 of the front section 72, and the rear face 78 of the front section 72. The first channel 82 comprises a first opening 84 in the rear face 78 of the front section 72, and a second opening 86 in the front face 80 of the front section 72. A first central axis 88 of the first channel 82 extends between the first opening 84 and the second opening 86 of the first channel 82. A width 90 of the first channel 82, measured perpendicularly to the first central axis 88, increases monotonically between the first opening 84 and the second opening 86 of the first channel 82.

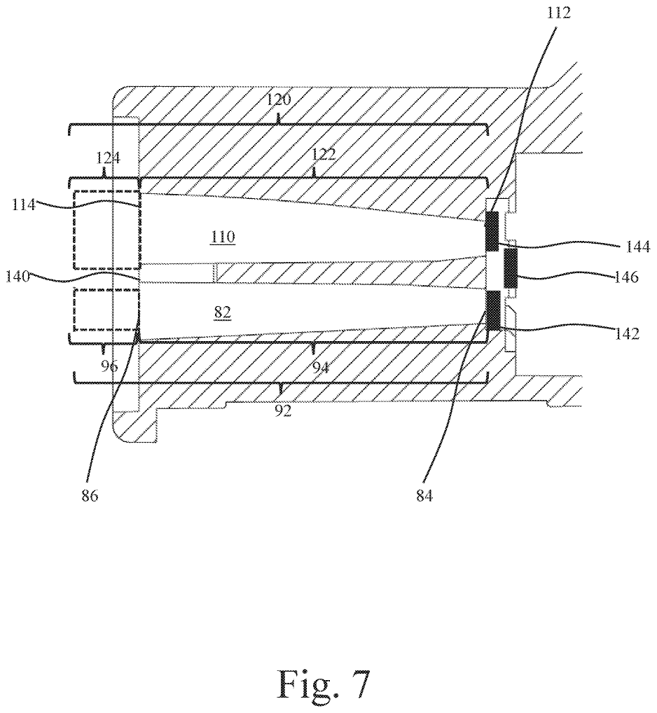

The portion of the first surface 74, which defines the first channel 82, conforms to the shape of a Compound Parabolic Concentrator (CPC) 92, and specifically has the shape of a truncated CPC 94. As shown in FIG. 7, the truncated CPC 94 is the CPC 92 with a section 96 removed, such that a length of the CPC 92, measured along the first central axis 88, is reduced. The section 96 removed from the CPC 92 is removed from an end of the CPC 96 which is furthest from the first opening 84 of the first channel 82 and thereby the section 96 removed from the CPC 92 is coincident with the second opening 86 of the first channel 82.

A length 98 of the portion of the first surface 74, which defines the first channel 82, measured along the first central axis 88 and between the first opening 84 and the second opening 86 of the first channel 82, is 10 mm. Lengths 98 of between 5 mm and 20 mm are also envisaged.

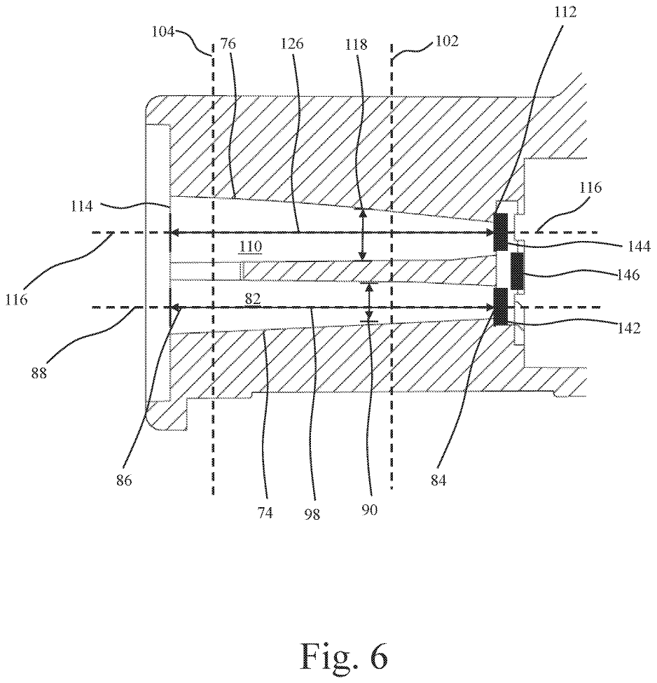

A longitudinal plane 100 extends between the first opening 84 and the second opening 86 of the first channel 82 and includes the first central axis 88. When viewed in the longitudinal plane 100 (FIGS. 6 and 7), the portion of the first surface 74 which defines the first channel 82 is curved, between the first opening 84 and the second opening 86 of the first channel 82. That is to say, the portion of the first surface 74 which defines the first channel 82 has a curved profile.

A first lateral plane 102 extends perpendicularly to the first central axis 88 and is spaced from the first opening 84 and the second opening 86 of the first channel 82. The first lateral plane 102 is located closer to the first opening 84 of the first channel 82 than the second opening 86 of the first channel 82. A second lateral plane 104 extends perpendicularly to the first central axis 88 and is spaced from the first opening 84 and the second opening 86 of the first channel 82. The second lateral plane 104 is located closer to the second opening 86 than the first opening 84 of the first channel 82.

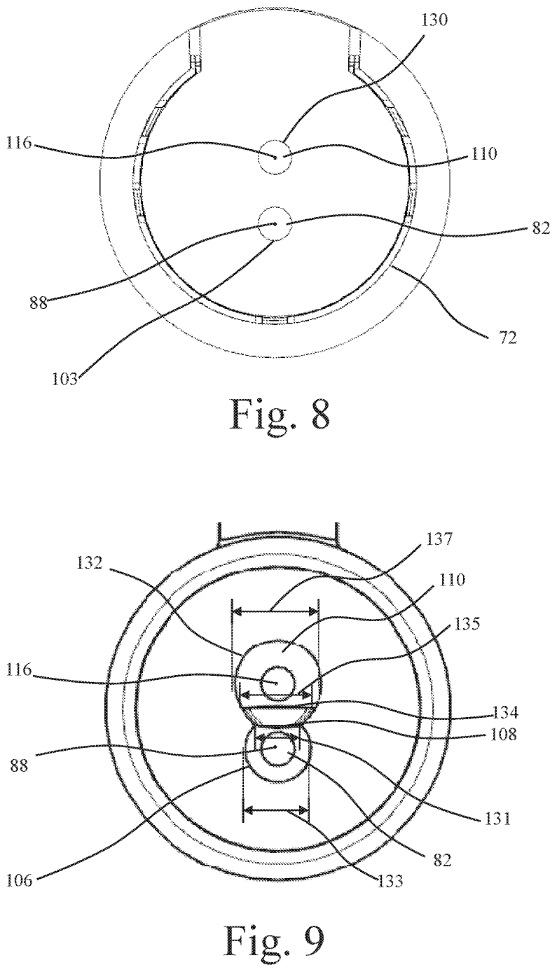

The first channel 82 has a first circular profile 103 (shown in FIG. 8) which is perpendicular to the first central axis 88, where the first lateral plane 102 bisects the first channel 82. The first channel 82 has a second profile 106,108 (shown in FIG. 9) which is perpendicular to the first central axis 88, where the second lateral plane 104 bisects the first channel 82. The second profile 106,108 has the shape of a first circular segment defined by a first circular arc 106 and a first circular chord 108. The first channel 82 transitions smoothly from the first circular profile 103 to the second profile 106,108 by a length 131 of the first circular chord 108 increasing gradually between the first circular profile 103 and the second profile 106,108.

The FoV restrictor 75 is a portion of a second surface 76 of the front section 72 which defines a second channel 110. The second channel 110 extends through the front section 72 between the front face 80 of the front section 72, and the rear fae of the front section 72. The second channel 110 comprises a first opening 112 in the rear face 78 of the front section 72, and a second opening 114 in the front face 80 of the front section 72. A second central axis 116 of the second channel 110 extends between the first opening 112 and the second opening 114 of the second channel 110. The second central axis 116 is parallel to the first central axis 88. A width 118 of the second channel 110 increases monotonically between the first opening 112 and the second opening 114 of the second channel 110. The width 118 of the second channel 110 is measured perpendicular to the second central axis 116. The second channel 110 is located closer to the strut 60 than the first channel 82 and the width 118 of the second channel 110 is greater than the width 90 of the first channel 82.

The portion of the second surface 76 which defines the second channel 110 conforms to the shape of a second CPC 120, and specifically has the shape of a second truncated CPC 120. As shown in FIG. 7, the second truncated CPC 120 is the second CPC 120 with a second section removed 124, such that a length of the second CPC 120, measured along the second central axis 116, is reduced. The second section 124 removed from the second CPC 120 is removed from an end of the second CPC 120 which is furthest from the first opening 112 of the second channel 110 and thereby the second section 124 removed from the second CPC 120 is coincident with the second opening 114 of the second channel 110.

A length 126 of the portion of the second surface 76 which defines the second channel 110, measured along the second central axis 116 and between the first opening 112 and the second opening 114 of the second channel 110, is 10 mm. Lengths 126 of between 5 mm and 20 mm are also envisaged.

The longitudinal plane 100 also extends between the first opening 112 and the second opening 114 of the second channel 110 and includes the second central axis 116. When viewed in the longitudinal plane 100 (shown in FIGS. 6 and 7), the portion of the second surface 76 which defines the second channel 110 is curved, between the first opening 112 and the second opening 114 of the second channel 110. That is to say, the portion of the second surface 76 which defines the second channel 110 has a curved profile.

The first lateral plane 102 also extends perpendicularly to the second central axis 116 and is spaced from the first opening 112 and the second opening 114 of the second channel 110. The first lateral plane 102 is located closer to the first opening 112 than the second opening 114 of the second channel 110. The second lateral plane 104 extends perpendicular to the second central axis 116 and is spaced from the first opening 112 and the second opening 114 of the second channel 110. The second lateral plane 104 is located closer to the second opening 114 than the first opening 112 of the second channel 110.

The second channel 110 has a second circular profile 130 (shown in FIG. 8) which is perpendicular to the first central axis 88, where the first lateral plane 102 bisects the second channel 110. The second channel 110 has a third profile 132,134 (shown in FIG. 9) which is perpendicular to the second central axis 116, where the second lateral plane 104 bisects the second channel 110. The third profile 132,134 has the shape of a second circular segment defined by a second circular arc 132 and a second circular chord 134. The second channel 110 transitions smoothly from the second circular profile 130 to the third profile 132,134 by a length 135 of the second circular chord 134 increasing gradually between the second circular profile 130 and the third profile 132,134.

The first circular chord 108 is opposite the second circular chord 134. Due to the increasing widths of the channels 82,110 and the relative closeness of the channels 82,110, the channels 82,110 may merge into one another, which may reduce the performance of the ToF sensor 64. By having the shape of circular segments with opposing chords, the channels 82,110 may be located close together whilst also reducing the amount of each channel 82,110 which merges with the other channel 82,110 and thereby reduces the performance of the ToF sensor 64.

A ratio of the length 131 of the first circular chord 108 to a diameter 133 of the first circular arc 106 is 0.9. Ratios of between 0.8 and 1 are also envisaged. A ratio of the length 135 of the second circular chord 134 to a diameter 137 of the second circular arc 132 is 0.9. Ratios of between 0.8 and 1 are also envisaged. Increasing the ratios may enable the channels 82,110 to be located closer together. Conversely, decreasing the rations may improve the performance of the channels 82,110 by reducing losses due to internal reflections. Having ratios in the range of 0.8 and 1, may provide a good balance between the competing needs of locating the channels 82,110 close together and improving the performance of the channels 82,110.

A third channel 140 is defined in the front face 80 of the front section 72. The third channel 140 extends between the first channel 82 and the second channel 110. The third channel 140 enables some optical radiation to pass between the first channel 82 and the second channel 110 to calibrate the ToF sensor.

The ToF sensor 64 is located within the chamber defined by the wall of the rear section 70 of the main unit 62 of the sensor assembly 22 and abuts the rear face 78 of the front section 72 of the main unit 62. The ToF sensor 64 comprises an emitter 142, a detector 144, and a processor 146.

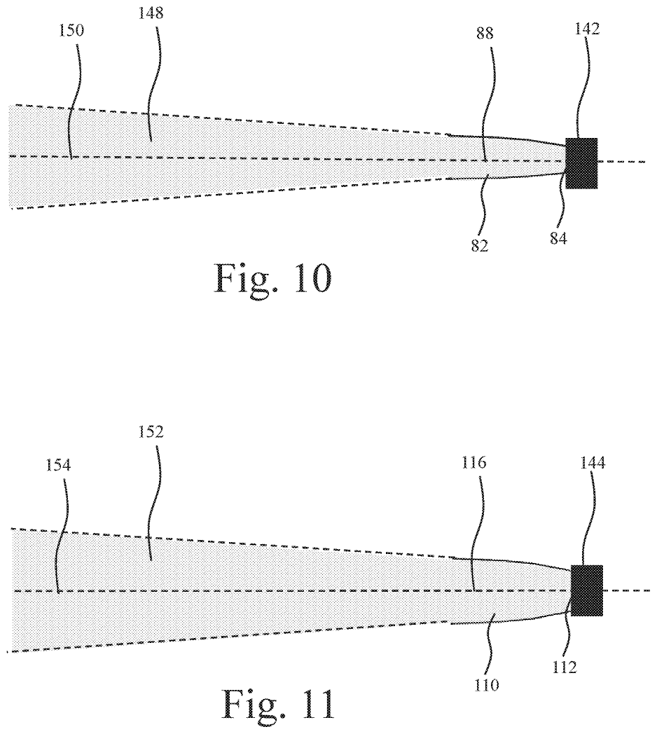

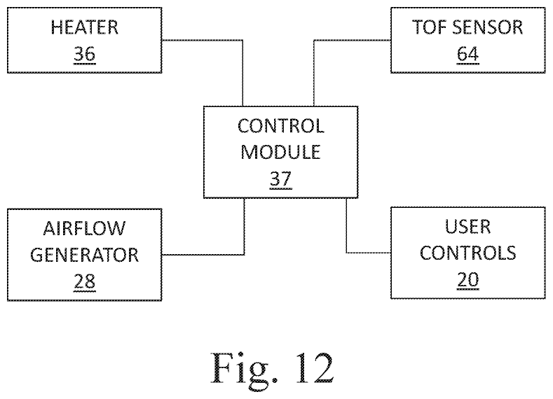

The emitter 142 emits optical radiation 148. The emitter 142 is aligned with the first channel 82 such that a beam axis 150 (shown in FIG. 10) of the optical radiation 148 emitted by the emitter 142 is aligned with the first central axis 88. The emitter 142 is coincident with, i.e. at, the first opening 84 of the first channel 82. The emitter 142 being near to the first opening 84 of the first channel 82 is also envisaged.

The detector 144 receives reflected optical radiation 152, which have been previously emitted by the emitter 142 and reflected back to the detector 144. The detector 144 is aligned with the second channel 110 such that a beam axis 154 of the reflected optical radiation 152 received by the detector 144 is aligned with the second central axis 116. The detector 144 is coincident with, i.e. at, the first opening 112 of the second channel 110. The detector 144 being near to the first opening 112 of the second channel 110 is also envisaged. A minimum distance 156 between the emitter 142 and the detector 144 (shown in FIG. 16) is 1.15 mm. Minimum distances 156 of less than 20 mm are also envisaged.

The processor 146 determines time differences between the ToF sensor 64 emitting and receiving the optical radiation 148,152 and from this calculates a distance between the ToF sensor 64 and a target to be detected (such as the head of a user of the hair dryer) which is responsible for reflecting the emitted optical radiation 148. The processor 146 then outputs this distance data to the control module 37. It is also envisaged that the processor 146 may be omitted and the control module 37 performs the determination.

The control module 37 is responsible for controlling the airflow generator 28 and/or the heater 36 in response to inputs from the ToF sensor 64 and the user controls 54. For example, in response to inputs from the user controls 54, the control module 37 may power on and off the airflow generator 28 and/or the heater 36. Additionally, the control module 37 may control the power or speed of the airflow generator 28 in order to vary the flow rate of the airflow. For example, repeatedly pressing the third button 56 may cause the control module 37 to cycle through different flow rates (e.g., low, medium and high). Similarly, the control module 37 may control the power of the heater 36 in order to vary the temperature of the airflow. For example, repeatedly pressing the fourth button 58 may cause the control module 37 to cycle through different temperature settings (e.g., cold, warm, hot).

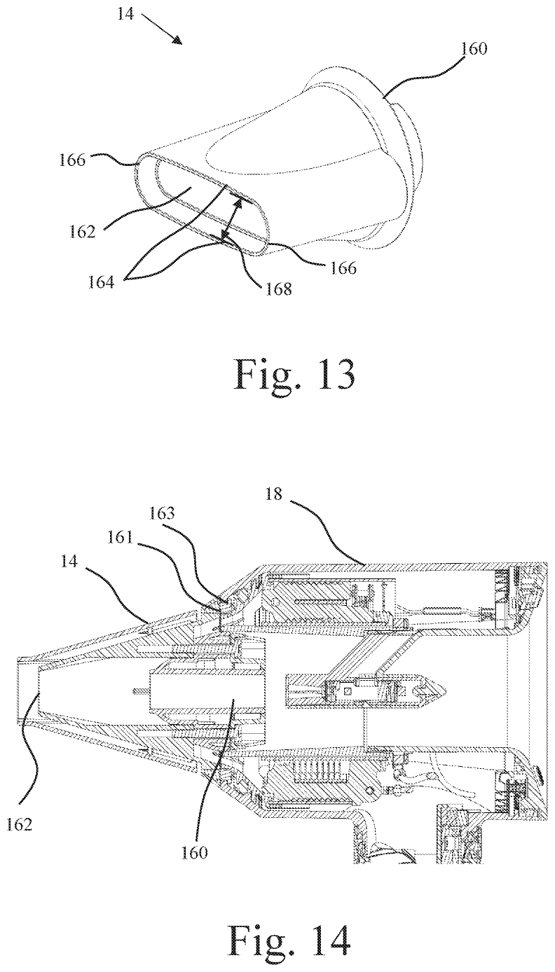

The attachment 14 (shown in FIGS. 1, 13, and 14) is detachably attached to the end of the barrel section 18 which comprises the outlet 44 of the housing 34. The attachment 14 has the shape of a concentrator and comprises an inlet 160, an annular magnet 161, and an outlet 162. The inlet 160 is generally circular in shape. The annular magnet 161 is arranged around the inlet 160. The annular magnet 161 is attracted to a ferrous ring 163 comprised by the barrel section 18 to secure the attachment 14 to the barrel section 18.

The outlet 162 is generally racetrack shaped. The racetrack shape is formed by two parallel straight sides 164 joined by two curved ends 166. A minimum width 168 of the outlet 162, measured between and perpendicular to the two parallel straight sides 164, is 12.25 mm. The outlet 162 is located in an opposite end of the attachment 14 to the inlet 160. Thereby, when the attachment 14 is attached to the barrel section 18, the outlet 162 is spaced from the barrel section 18. The area of the outlet 162 is less than the area of the inlet 160. When the attachment 14 is attached to the barrel section 18, the attachment 14 is located such that the first central axis 88 and the second central axis 116 extend through the inlet 160 and the outlet 162 of the attachment 14, and thereby the ToF sensor 64 has a line of sight through the attachment 14.

During operation of the hair dryer 10, the airflow generator 28 generates an airflow which moves from the inlet 30 of the handle 16, to the outlet 32 of the handle 16, through the inlet 42 of the housing 34, over the heater 36, out of the outlet 44 of the housing 34, and through the attachment 14, where it is emitted towards, and hits, the head of a user which is proximate to the outlet 162 of the attachment 14.

The emitter 142 emits optical radiation 148. The emitted optical radiation 148 is directed between the first opening 84 and the second opening 86 of the first channel 82 by the portion of the first surface 74 which defines the first channel 82. Some of the emitted optical radiation 148 hits the portion of the first surface 74 which defines the first channel 82 and is reflected from the portion of the first surface 74. This restricts the emitted optical radiation 148 and thereby restricts a FoI of the emitter 142. The emitted optical radiation 148 then proceeds out of the outlet 48 of the bore 46 and through the inlet 160 and the outlet 162 of the attachment 14. The emitted optical radiation 148 then hits, and is reflected from the head of a user (i.e. a target to be sensed). The reflected optical radiation 152 then travels back through the outlet 162 and inlet 160 of the attachment 14.

The reflected optical radiation 152 then enters the second opening 114 of the second channel 110. The portion of the second surface 76 then directs some of the reflected optical radiation 152 between the second opening 114 and the first opening 112 of the second channel 110. Specifically, reflected optical radiation 152 with an angle, measured from the second central axis 116, less than an acceptance angle 171 (described below in more detail) of the second channel 110 either travels directly between the second opening 114 and the first opening 112, or hits the portion of the second surface 76 and is reflected from the portion of the second surface 76 towards the first opening 112 of the second channel 110. The optical radiation 152 directed towards the first opening 112 is then received by the detector 144. Reflected optical radiation 152 with an angle greater than the acceptance angle 171 of the second channel 110 hits the portion of the second surface 76 and is reflected from the portion of the second surface 76 towards the second opening 114 of the second channel 110 and is thereby rejected from the second channel. This restricts the reflected optical radiation 152 which can be received by the detector 144 and thereby restricts a FoV of the detector 144.

The processor 146 then determines the time difference between the ToF sensor 64 emitting and receiving the optical radiation 148,152 and from this calculates a distance between the ToF sensor 64 and the head of the user. The processor 146 then outputs this distance data to the control module 37.

The control module 37 then modifies the power provided to the heater 36 based on the distance data to control the temperature of the airflow hitting the head of the user. For example, in response to the ToF sensor 64 determining that the distance between the ToF sensor 64 and the head of the user is reducing, the control module 37 may power down the heater 36. In response to the ToF sensor 64 determining that the distance between the ToF sensor 64 and the head of the user is increasing, the control module 37 may power up the heater 36. This may maintain a constant temperature at the head of the user.

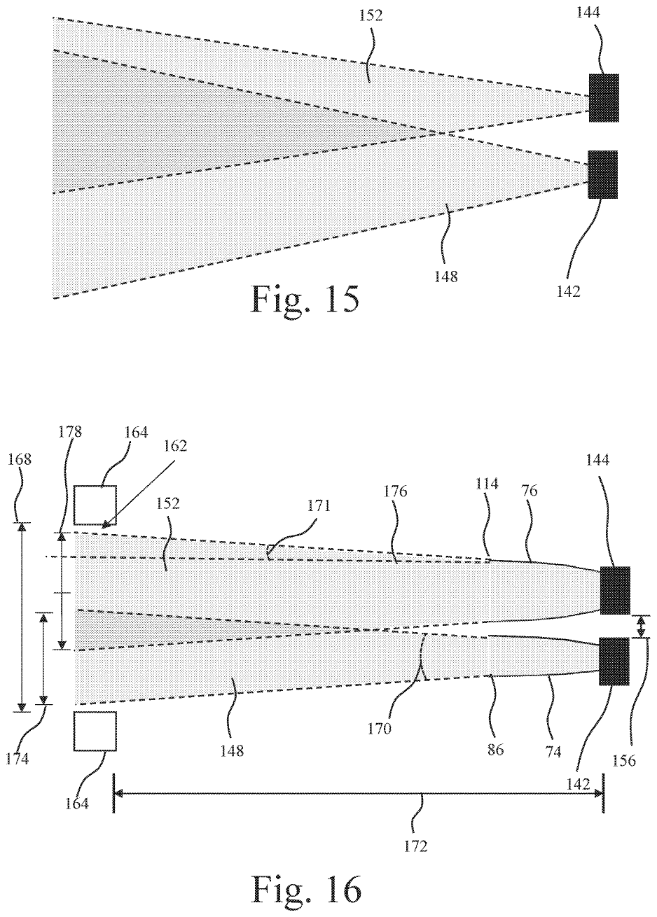

As described above, the portion of the first surface 74 which defines the first channel 82 is shaped such that the portion 74 restricts the FoI of the emitter 142. This is shown comparatively by FIG. 15, in which the portion of the first surface 74 is not present and the FoI is unrestricted, and FIG. 16, in which the of the first surface 74 is present and the FoI is restricted. Specifically, the portion of the first surface 74 is shaped such that a full width at half maximum (FWHM) beam divergence 170 of the emitted optical radiation 148 at the second opening 86 of the first channel 82 is 8°. The FWHM beam divergence 170 may also be referred to as a FWHM beam divergence angle. A FWHM beam divergence 170 of between 4° and 20° is also envisaged.

The sensor assembly 22 is located such that a distance 172, measured along the first central axis 88 between the emitter 142 and the outlet 162 of the attachment 14 is 84.75 mm. Due to this distance 172 and the FWHM beam divergence 170 of the emitted optical radiation 148, a FWHM beam width 174 of the emitted optical radiation 148, at the outlet 162 of the attachment 14, is 15 mm. Thereby, a ratio of the FWHM beam width 174 of the emitted optical radiation 148 at the outlet 162 of the attachment 14 to the minimum width 168 of the outlet 162 is approximately 1.2. Ratios of less than or equal to 1.5 are also envisaged.

As described above, the portion of the second surface 76 which defines the second channel 110 is shaped such that the portion 76 restricts the FoV of the detector 144. This is shown comparatively by FIG. 15, in which the portion of the second surface 76 is not present and the FoV is unrestricted, and FIG. 16, in which the portion 76 is present and the FoV is restricted. Specifically, the portion of the second surface 76 is shaped such that the acceptance angle 171 of the second channel 110 (measured at the second opening 114 of the second channel 110) is 6.5 °. The acceptance angle 171 is the maximum angle, measured from an axis 176 parallel to the second central axis 116, of reflected optical radiation 152 which can be directed by the portion of the second surface 76 from the second opening 114 to the first opening 112 of the second channel 110 and therefore received by the detector 144. An acceptance angle 171 of between 3° and 10° is also envisaged.

The sensor assembly 22 is located such that a distance 172, measured along the second central axis 116 between the detector 144 and the outlet 162 of the attachment 14 is 84.75 mm. Due to this distance 172 and the acceptance angle 171 of the second channel 110, a width 178 of the FoV at the outlet 162 of the attachment 14 is 15 mm. Thereby, a ratio of the width 178 of the FoV at the outlet 162 of the attachment 14 to a minimum width 168 of the outlet 162 is approximately 1.2. Ratios of less than or equal to 1.5 are also envisaged.

The portion of the first surface 74 and the portion of the second surface 76 each have a surface roughness of 6 nm. A surface roughness of between 4 nm and 7 nm is also envisaged. Having a surface roughness in the range of 4 nm to 7 nm may provide a good balance between the competing needs to increase the amount of optical radiation reflected by the portions 74,76 (and thereby directed by the portions 74,76), and decreasing the cost of manufacturing the portions 74,76.

The portion of the first surface 74 and the portion of the second surface 76 each have an absorbance of 80% to 90%. An absorbance of above 60% is also envisaged. As a result, the amount of optical radiation which is not absorbed and instead reflected as diffuse optical radiation, which may constitute noise to the detector 144 or not be usefully directed towards an object to be sensed by the emitter 142, may be reduced.

In the above example, the second surface 76 which defines the second channel 110 conforms to the shape of a second CPC 120. Compound parabolic concentrators may be beneficial when compared to other types of curved surfaces, such as parabolic concentrators, because the former may be able to accept optical radiation which is not perpendicular to the second opening 114 and direct this optical radiation to the detector 144. In contrast, a parabolic concentrator, for example, may be only able to accept and direct optical radiation which is perpendicular to the second opening 110. Thereby, a greater amount of optical radiation may be received by the detector 114 which may increase the signal strength and/or signal to noise ratio. Additionally, compound parabolic concentrators may offer better trade offs between peak ideal performance and tolerance to performance drop due to misalignment and/or manufacturing tolerances, when compared to other shapes such as a parabolic concentrator.

In the above example, the FoV and FOI restrictors 73,75 are used with a ToF sensor 64. However, it is envisaged that the FoV and/or FoI restrictor 73,75 may be used with other types of optical devices.

In the above example, the FoV and FoI restrictors 73,75 each comprise a respective portion of a respective surface 74,76 which directs the optical radiation 148,152. In other examples, the FoV and/or FoI restrictor 73,75 may instead comprise an occlusion or a lens for restricting the FoI and/or FoV.

1. A hair dryer, comprising:
an optical device, the optical device comprising an emitter configured to emit optical radiation and a detector configured to receive optical radiation;
a field of illumination restrictor configured to restrict a field of illumination of the emitter; and
a field of view restrictor configured to restrict a field of view of the detector,
wherein the field of view restrictor is separate to the field of illumination restrictor.

2. The hair dryer of claim 1, wherein:
the field of illumination restrictor is configured to restrict the field of illumination of the emitter such that, in use, a full width at half maximum beam divergence of the optical radiation after the optical radiation has passed through the field of illumination restrictor has a first value;
wherein the field of view restrictor is configured to restrict the field of view of the detector such that an acceptance angle of the field of view restrictor has a second value; and
the first value is different to the second value.

3. The hair dryer of claim 2, wherein the second value is larger than the first value.

4. The hair dryer of claim 1, wherein a minimum distance between the emitter and the detector is less than or equal to 20 mm.

5. The hair dryer of claim 1, wherein the field of illumination restrictor is configured to restrict the field of illumination of the emitter such that, in use, a full width at half maximum beam divergence of the optical radiation after the optical radiation has passed through the field of illumination restrictor is less than or equal to 20°.

6. The hair dryer of claim 1, wherein the field of illumination restrictor is configured to restrict the field of illumination of the emitter such that, in use, a full width at half maximum beam divergence of the optical radiation after the optical radiation has passed through the field of illumination restrictor is greater than or equal to 4°.

7. The hair dryer of claim 1, wherein the field of view restrictor is configured to restrict the field of view of the detector such that an acceptance angle of the field of view restrictor is less than or equal to 20°.

8. The hair dryer of claim 1, wherein the field of view restrictor is configured to restrict the field of view of the detector such that an acceptance angle of the field of view restrictor is greater than or equal to 3°.

9. The hair dryer of claim 1, wherein:
the hair dryer comprises a main body; and
the optical device, the field of illumination restrictor, and the field of view restrictor are located inside the main body.

10. The hair dryer of claim 9, wherein:
the hair dryer comprises an attachment attachable to the main body;
the attachment comprises an outlet which is spaced apart from the main body when the attachment is attached to the main body; and
the field of illumination restrictor is configured to:
restrict the field of illumination such that, in use, a ratio of a full width at half maximum beam width of the optical radiation at the outlet of the attachment to a minimum width of the outlet of the attachment is less than or equal to 1.5;
or the field of view restrictor is configured to restrict the field of view such that a ratio of a width of the field of view at the outlet of the attachment to the minimum width of the outlet of the attachment is less than or equal to 1.5.

11. The hair dryer of claim 1, wherein the optical device is a time of flight sensor.

12. The hair dryer of claim 1, wherein:
the hair dryer comprises a first surface;
the field of illumination restrictor is a portion of the first surface which defines a first channel, the first channel aligned with the emitter;
the first channel comprises a first opening, a second opening further from the emitter than the first opening, and a width which increases monotonically between the first opening and the second opening; and
the portion of the first surface that defines the first channel is configured to direct the optical radiation between the first opening and the second opening.

13. The hair dryer of claim 12, wherein:
the first channel has a central axis extending between the first opening and the second opening; and
at least a portion of the first channel has a circular profile about the central axis;
and/or the portion of the first surface which defines the first channel is curved, between the first opening and the second opening, in a plane that includes the central axis.

14. The hair dryer of claim 13, wherein, when the first surface which defines the first channel is curved, between the first opening and the second opening, in a plane that includes the central axis, the portion of the first surface which defines the first channel and is curved, between the first opening and the second opening, conforms to the profile of a compound parabolic concentrator.

15. The hair dryer of claim 14, wherein the portion of the first surface which defines the first channel and is curved, between the first opening and the second opening, has the shape of a truncated compound parabolic concentrator.

16. The hair dryer of claim 15, wherein:
the shape of a truncated compound parabolic concentrator is a compound parabolic concentrator with a section removed, such that a length of the compound parabolic concentrator, measured along the central axis, is reduced; and
the section removed from the compound parabolic concentrator is coincident with the second opening.

17. The hair dryer of claim 12, wherein the portion of the first surface has a minimum length, measured between the first opening and the second opening, of less than or equal to 20 mm and/or greater than or equal to 5 mm.

18. The hair dryer of claim 12, wherein the emitter is coincident with the first opening of the first channel.

19. The hair dryer of claim 1, wherein:
the hair dryer comprises a second surface;
the field of view restrictor is a portion of the second surface which defines a second channel, the second channel aligned with the detector;
the second channel comprises a first opening, a second opening further from the detector than the first opening of the second channel, and a width which increases monotonically between the first opening of the second channel and the second opening of the second channel; and
the portion of the second surface that defines the second channel is configured to direct the optical radiation between the first opening of the second channel and the second opening of the second channel.
